(19) United States
(12) Patent Application Publication
(10) Pub. No.: US 2005/0046056 A1
(43) Pub. Date: Mar. 3, 2005

(54) Method of molding articles

(76) Inventors: Jiawen Dong, Rexford, NY (US); Christopher Goewey, Pittsfield, MA (US); Bruce Harper, Great Barrington, MA (US); Eugene David Herrmann, Clifton Park, NY (US); Robert John Hossan, Delmar, NY (US); Matt Niemeyer, North Chatham, NY (US)

Correspondence Address: CANTOR COLBURN, LLP, 55 GRIFFIN ROAD SOUTH, BLOOMFIELD, CT, 06002, US

(21) Appl. No.: 10/648,540

(22) Filed: Aug. 26, 2003

(51) Int. Cl. B29C 45/00

(52) U.S. Cl. 264/1.33; 264/328.16; 264/40.1

(57) ABSTRACT

A method of molding a disk having improved physical and/or mechanical properties, such as physical stability is described. The method is useful in the molding of disks and disk substrates for data storage media.

### BACKGROUND OF INVENTION

Current high performance storage technology includes optical, magnetic and magneto-optic media, which provide high storage capacity. Areal density, typically expressed as billions of bits per square inch of disk surface area (gigabits per square inch (Gbits/in²)), is equivalent to the linear density (bits of information per inch of track) multiplied by the track density in tracks per inch. Improved areal density has been one of the key factors in the price reduction per megabyte, and further increases in areal density continue to be demanded by the industry.

Polymeric data storage media have been employed in areas such as compact disks (CD) and recordable or re-writable compact discs (e.g., CD-R and CD-RW), and similar relatively low areal density devices, e.g. less than about 1 Gbits/in², which are typically read-through devices requiring the employment of a good optical quality substrate having low birefringence.

Unlike the CD, storage media having high areal density capabilities, typically up to or greater than about 5 Gbits/in², employ first surface or near field read/write techniques in order to increase the areal density. For such storage media, although the optical quality of the substrate is not relevant, the physical and mechanical properties of the substrate become increasingly important. For high areal density applications, including first surface applications, the surface quality of the storage media can affect the accuracy of the reading device, the ability to store data, and replication qualities of the substrate. Furthermore, the physical characteristics of the storage media when in use can also affect the ability to store and retrieve data; i.e. the axial displacement of the media, if too great, can inhibit accurate retrieval of data and/or damage the read/write device.

Recent advances in high definition TV require a unique high density recording media known in the industry as digital video recording (DVR, such as BLU-RAY DISC). DVR disk assemblies generally comprise a data storage layer metallized onto a 1.1 millimeter (mm) thick substrate and covered by an optical film via a clear adhesive. The substrate is typically a polymeric material, which may or may not be the same material as the optical film. This assembly must meet industry standard specifications for disk flatness, the deviation from which is known as radial tilt. A minimum change in radial tilt is required for the environments in which the assembly will be exposed throughout its lifetime. Predictive tests for determining dimensional stability of a disk may be made by thermal aging the disk assembly at 80° C. for a hundred hours followed by measuring the radial tilt. Time, temperature, and humidity may all play a role in affecting the tilt of an assembly comprising layers of material that exhibit differential rates of shrinkage.

In addition to disk flatness, the disk assembly must also meet a minimum specification for feature replication. Typically a disk substrate is molded using a mold master containing a mold insert or stamper which comprises a pattern of features having particular dimensions in the micrometer or nanometer range. When molded, the disk substrate takes on the pattern as a negative of the stamper pattern. The replicated pattern must have grooves substantially identical in measurement to the pattern on the stamper. A 90 percent or greater replication of the stamper features is often required for storage media possessing high areal density capabilities.

It is difficult with currently available materials and methods to consistently and reliably meet the specifications required of storage media having high areal density capabilities. Hence, there remains a need in the art for a method of molding disk substrates to maximize the dimensional stability and groove depth replication of the disk substrate.

### SUMMARY OF INVENTION

Disclosed herein is a method of molding a disk comprising injection molding a polymeric material to form disks according to a molding model comprising molding parameters and molding parameter values; testing disk assemblies fabricated from the disks for radial tilt change; creating an updated molding model based on the molding parameter values that resulted in disk assemblies fabricated from the disks having a radial tilt change within a selected range of values; and repeating the molding, testing and creating steps to form final disks and a final molding model, wherein disk assemblies fabricated from the final disks exhibit a radial tilt change value after aging of less than or equal to about 0.35 degree measured at a radius of 55 millimeters.

In another embodiment, a method of molding a disk comprises injection molding a polymeric material at a melt temperature of about 330 to about 370° C. into mold having a mold temperature of about 90 to about 130° C. and a clamp tonnage of about 12 to about 35 tons to form a disk.

The above described and other features are exemplified by the following figures and detailed description.

### BRIEF DESCRIPTION OF DRAWINGS

FIG. 1 displays the effect of molding parameters on radial tilt change and groove depths for disk assemblies prepared from initial molding runs.

### DETAILED DESCRIPTION

It has been found that molded-in stresses in a molded article, especially disks and disk substrates, may be significantly reduced by carefully choosing the particular molding conditions used to mold the article. Molded-in stresses in a disk substrate may be released over time or at elevated temperatures resulting in shrinkage of the disk or disk substrate. When disk assemblies comprise the disks or disk substrates, the release of molded in stresses may lead to radial tilt of the disk assembly. The minimization of molded in stresses and concomitant increase in physical stability of the molded disk is especially desirable for high areal data storage disks and disk substrates. It has been unexpectedly found that certain molding parameters such as, for example, mold temperature and melt temperature significantly affect the quality of a disk substrate in terms of its physical stability, and careful choice of these molding conditions results in a molded disk substrate having increased dimensional stability. These molding parameters also have a significant effect on the disk's feature replication as well.

The term radial tilt as used herein refers to the degrees by which an article, such as a disk, bends on a horizontal axis and is typically measured as the vertical deviation at the outer radius of the disk. Typically the radial tilt is determined by measuring the deflection of a laser beam incident at some angle to the disk. From geometrical considerations the deflection of the laser beam is equal to two times the radial tilt angle. This is denoted as the radial deviation and is two times the tilt angle measured in degrees. A change in radial tilt refers to the difference between the radial tilt measurement of a newly prepared disk to the radial tilt of the disk after exposure to temporal and environmental conditions, including elevated temperature and/or humidity.

The terms molding conditions and molding parameters as used herein may be used interchangeably. The term disk or disk substrate as used herein may be used interchangeably.

It has been advantageously determined that certain molding parameters significantly affect the amount of molded in stresses in a molded article, such as a disk. By determining which molding parameters affect the extent of molded in stresses, and in turn the amount of radial tilt of disk assemblies fabricated from the molded disks, an optimum molding process or molding model may be developed to mold disks exhibiting good physical stability. Additionally, the molding parameters that affect percent replication of a disk may also be determined to form an optimum molding process or molding model to mold disks exhibiting good percent feature replication of mold features. Using the method described herein, it is possible to determine the optimum molding conditions to mold a disk, regardless of the type of molding equipment or the type of polymeric material used, to result in a disk having greatly improved radial tilt change and/or percent replication.

Articles or disks are first molded according to an initial molding model. The initial molding model may comprise initial molding parameters and their corresponding initial molding parameter value ranges, which may be described as operating ranges. The initial molding model may be created based on the known physical properties of the material used to form the disks, such as a particular polymeric material. This knowledge is often used in conjunction with known molding parameter value ranges used for the type of molding process employed. For example, based on the composition of a polymeric material having a known glass transition temperature (Tg) and a known viscosity, a range of injection molding parameter values for the molding parameters melt temperature and mold temperature may be predicted and used to develop the initial molding model. Any number of initial molding parameters and their corresponding initial molding parameter value ranges may be developed for the creation of the initial molding model. Useful in the development of the molding models is the application of training methods such as design of experiment (DOE) techniques.

Molding parameters for injection molding a polymeric material to form a disk may include melt temperature of the polymeric material, the temperature to which the polymer is heated above its Tg to reduce its viscosity to allow a shot to be injected into the mold; mold temperature, the temperature of the mold chamber used to form the molded part, usually below the polymeric material's Tg; clamping tonnage, the force used to keep the two mold halves clamped together during cooling; hold pressure, the pressure applied to the melt in the mold during cooling; cool time, the time allowed for the article to cool in the mold; and the like. Additional molding parameters include, but are not limited to, clamping time, the amount of time the clamping force is applied to keep the two mold halves together; hold time, the amount of time the hold pressure is applied; injection speed, the velocity at which the polymeric material shot is injected into the mold, which may influence material pressure during injection fill, material temperature due to shear, and total time of injection; transfer point, the screw position that indicates when injection control switches from position control to pressure control, and which may influence the total amount of material injected into the mold cavity and the amount of cavity pressure at the end of the fill and the beginning of hold; punch delay time, the time delay from the end of the hold time or transfer point to when the internal diameter hole of the disk is punched, punch delay time may influence the internal diameter hole size and quality; air blow delay and time, the delay time for air blow and acting time of air blow on the disk which is used to separate the molded disk from the mold, and which may influence disk shape; off-set temperature, the temperature of the mold's mirror blocks (both the moving side mirror and stationary side mirror) may be set at different temperatures to induce unbalanced or balanced cooling of the disk in the mold; punch temperature, the temperature of coolant circulated through the internal diameter punch in the tool, which may influence temperature and cooling rates on the internal diameter of the disk as well as the internal diameter hole size; sprue temperature, the temperature of the coolant circulated through the mold sprue, which may influence temperature and cooling rates on the internal diameter of the disk as well as the cooling rates of melt in the sprue.

A design of experiments (DOE) approach may be used to determine the initial molding parameter value ranges and subsequent molding parameter value ranges for the creation of updated molding models. The extremes and midpoints of each of these molding parameter value ranges are developed for each molding model and used to understand the effects of each of these parameters, or combinations of parameters, on a measurable selected physical or mechanical property of the molded disk. For instance, the disks may be tested for percent feature replication. The percent feature replication is based on a comparison of the measurements of the mold stamper features with the measurements of the matching features of the disk itself. Alternatively or additionally, the disks may be formed into disk assemblies that are then tested for a radial tilt change upon aging for a time under conditions of temperature and/or humidity. An aging test may include subjecting the disk or disk assemblies to increased temperature and/or humidity over a defined period of time. An exemplary aging test may be performed by exposing the disks or disk assemblies to 96 hours of 80° C. temperature. In another aging test, the disks or disk assemblies may be exposed to 96 hours of 80° C. temperature and 50% relative humidity.

The results of the testing for a physical or mechanical property of the disks may be compared to a selected range of values for the particular property. This information, and the molding parameters that resulted in such a property value, is used to create an updated molding model. The molding parameter values resulting in disks that have a property value falling within a selected range of values is used for the updated molding model.

In one embodiment, the molding parameters that substantially affect the selected physical or mechanical property that is tested (such as percent feature replication or radial tilt change) are isolated. For instance, if the mold temperature parameter substantially affects the radial tilt change of a disk assembly after 96 hours of 80° C. and 50% relative humidity exposure, the updated molding model would comprise a mold temperature parameter value range adjusted from the prior molding model. Substantially affects means that the selected molding parameter has a statistically significant effect on the selected property with a confidence level of 95 percent or more as determined by generally accepted statistical tests. Those molding parameters that do not substantially affect the selected physical or mechanical properties are maintained in the updated molding model at a value as defined in the prior molding model.

The updated molding model may further be updated in response to repeating the steps of molding articles, testing the articles, and creating an updated molding model to optimize the molding model. The final molding model provides an injection molded disk exhibiting a desired range of physical or mechanical properties having values within a selected value range. The selected mechanical or physical property value ranges may be used to define the minimum specification requirements the disk must adhere to for quality control purposes. It is desirable for a disk to exhibit a percent feature replication of greater than or equal to about 90 percent, with greater than or equal to about 92 percent preferred, with greater than or equal to about 94 percent more preferred, and greater than or equal to about 95 percent most preferred. It is also desirable that a disk assembly fabricated from a disk formed by the methods described herein exhibits a radial tilt change value after 96 hours at 80° C. of less than or equal to about 0.5 degree measured at a radius of 55 millimeters. Within this range a radial tilt change value after 96 hours at 80° C. of less than or equal to about 0.35 degree is preferred, with less than or equal to about 0.25 degree more preferred, and less than or equal to about 0.15 degree even more preferred.

In one embodiment, a method of injection molding a polymeric material to form disks is based on the molding parameters of melt temperature, mold temperature, and clamp tonnage. A melt temperature of about 330 to about 370° C. may be used. Within this range a melt temperature of greater than or equal to about 340° C. is preferred, with greater than or equal to about 350° C. more preferred. Also within this range a melt temperature of less than or equal to about 360° C. is preferred, with less than or equal to about 355° C. more preferred.

A mold temperature of about 90 to about 130° C. may be used. Within this range a mold temperature of greater than or equal to about 100° C. may be used, with greater than or equal to about 110° C. preferred, and with 115° C. more preferred. Also within this range a mold temperature of less than or equal to about 125° C. is preferred, with less than or equal to about 120° C. more preferred.

A clamp tonnage of greater than about 12 tons may be used and preferably about 12 to about 35 tons may be used. Within this range a clamp tonnage of greater than or equal to about 15 is preferred, with greater than or equal to about 20 more preferred. Also within this range a clamp tonnage of less than or equal to about 30 is may be used, with less than or equal to about 25 also suitable.

A cool time of about 1 to about 35 seconds may be used. Within this range a cool time of greater than or equal to about 5 seconds is preferred, with greater than or equal to about 7 seconds more preferred, and greater than or equal to about 12 seconds even more preferred. Also within this range a cool time of less than or equal to about 25 seconds may be used, with less than or equal to about 20 seconds preferred, and less than or equal to about 15 seconds more preferred.

A hold pressure of about 1 to about 40 kgf/cm² may be used. Within this range a hold pressure of greater than or equal to about 5 kgf/cm² is preferred, with greater than or equal to about 10 kgf/cm² more preferred, and greater than or equal to about 15 kgf/cm² even more preferred. Also within this range a hold pressure of less than or equal to about 35 kgf/cm² may be used, with less than or equal to about 30 kgf/cm² preferred, and less than or equal to about 25 kgf/cm² more preferred.

Any type of article that may be molded from a polymeric material may be prepared. In an exemplary embodiment, the molding method may be applied to injection molding disks and disk substrates, including direct injection molding. WO 02/43943 to Adedeji et al. generally describes a direct molding process. In particular, the method of molding can be applied to injection molding data storage disks or disk substrates such as DVD, DVD-R, CD, and disk substrates for DVR, and the like.

Suitable polymeric material includes polycarbonate, poly(arylene ether); poly(alkenyl aromatic); polyolefins; diene-derived polymers such as polybutadiene and polyisoprene; polyacrylamide; polyamides; polyesters; polyestercarbonates; polyethersulfones; polyetherketones; polyetherimides; copolymers thereof; blends of the foregoing; and the like. Preferred polymeric material includes poly(arylene ether) and poly(alkenyl aromatic) blends.

The term poly(arylene ether) includes polyphenylene ether (PPE) and poly(arylene ether) copolymers; graft copolymers; poly(arylene ether) ether ionomers; and block copolymers of alkenyl aromatic compounds, vinyl aromatic compounds, and poly(arylene ether), and the like; and combinations comprising at least one of the foregoing; and the like. Poly(arylene ether)s per se, are known polymers comprising a plurality of structural units of the formula (I): 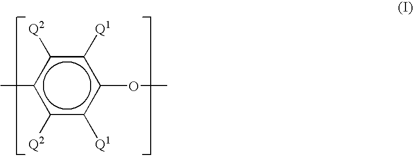
wherein for each structural unit, each Q¹ is independently halogen, primary or secondary lower alkyl (e.g., alkyl containing up to 7 carbon atoms), phenyl, haloalkyl, aminoalkyl, hydrocarbonoxy, or halohydrocarbonoxy wherein at least two carbon atoms separate the halogen and oxygen atoms, or the like; and each Q² is independently hydrogen, halogen, primary or secondary lower alkyl, phenyl, haloalkyl, hydrocarbonoxy, or halohydrocarbonoxy wherein at least two carbon atoms separate the halogen and oxygen atoms, or the like. Preferably, each Q¹ is alkyl or phenyl, especially C₁₋₄ alkyl, and each Q² is hydrogen or C₁₋₄ alkyl. It will be understood that the term “haloalkyl” includes alkyl groups substituted with one or more halogen atoms, including partially and fully halogenated alkyl groups.

Both homopolymer and copolymer poly(arylene ether) are included. The preferred homopolymers are those containing 2,6-dimethylphenylene ether units. Suitable copolymers include random copolymers containing, for example, such units in combination with 2,3,6-trimethyl-1,4-phenylene ether units or copolymers derived from copolymerization of 2,6-dimethylphenol with 2,3,6-trimethylphenol. Also included are poly(arylene ether) containing moieties prepared by grafting vinyl monomers or polymers such as polystyrenes, as well as coupled poly(arylene ether) in which coupling agents such as low molecular weight polycarbonates, quinones, heterocycles and formals undergo reaction in known manner with the hydroxy groups of two poly(arylene ether) chains to produce a higher molecular weight polymer. Poly(arylene ether)s further include combinations comprising at least one of the above. Preferred poly(arylene ether)s are poly(2,6-dimethylphenylene ether) and poly(2,6-dimethylphenylene ether-co-2,3,6-trimethylphenylene ether) such as those described in U.S. Pat. No. 6,407,200 to Singh et al. and U.S. Pat. No. 6,437,084 to Birsak et al.

The poly(arylene ether) generally has a number average molecular weight of about 3,000-40,000 atomic mass units (amu) and a weight average molecular weight of about 20,000-80,000 amu, as determined by gel permeation chromatography. The poly(arylene ether) may have an intrinsic viscosity of about 0.10 to about 0.60 deciliters per gram (dl/g), preferably about 0.29 to about 0.48 dl/g, as measured in chloroform at 25° C. It is also possible to utilize a high intrinsic viscosity poly(arylene ether) and a low intrinsic viscosity poly(arylene ether) in combination. Determining an exact ratio, when two intrinsic viscosities are used, will depend somewhat on the exact intrinsic viscosities of the poly(arylene ether) used and the ultimate physical properties that are desired.

The poly(arylene ether)s are typically prepared by the oxidative coupling of at least one monohydroxyaromatic compound such as 2,6-xylenol or 2,3,6-trimethylphenol. Catalyst systems are generally employed for such coupling; they typically contain at least one heavy metal compound such as a copper, manganese or cobalt compound, usually in combination with various other materials.

Particularly useful poly(arylene ether)s for many purposes are those which comprise molecules having at least one aminoalkyl-containing end group. The aminoalkyl radical is typically located in an ortho position to the hydroxy group. Products containing such end groups may be obtained by incorporating an appropriate primary or secondary monoamine such as di-n-butylamine or dimethylamine as one of the constituents of the oxidative coupling reaction mixture. Also frequently present are 4-hydroxybiphenyl end groups, typically obtained from reaction mixtures in which a by-product diphenoquinone is present, especially in a copper-halide-secondary or tertiary amine system. A substantial proportion of the polymer molecules, typically constituting as much as about 90 percent by weight of the polymer, may contain at least one of said aminoalkyl-containing and 4-hydroxybiphenyl end groups.

In one embodiment, the poly(arylene ether) comprises a capped poly(arylene ether). The capping may be used to prevent the oxidation of terminal hydroxy groups on the poly(arylene ether) chain. The terminal hydroxy groups may be inactivated by capping with an inactivating capping agent via an acylation reaction, for example. The capping agent chosen is desirably one that results in a less reactive poly(arylene ether) thereby reducing or preventing crosslinking of the polymer chains and the formation of gels or black specks during processing at elevated temperatures. Suitable capping agents include, for example, esters of salicylic acid, anthranilic acid, or a substituted derivative thereof, and the like; esters of salicylic acid, and especially salicylic carbonate and linear polysalicylates, are preferred. As used herein, the term “ester of salicylic acid” includes compounds in which the carboxy group, the hydroxy group, or both have been esterified. Suitable salicylates include, for example, aryl salicylates such as phenyl salicylate, acetylsalicylic acid, salicylic carbonate, and polysalicylates, including both linear polysalicylates and cyclic compounds such as disalicylide and trisalicylide. The preferred capping agents are salicylic carbonate and the polysalicylates, especially linear polysalicylates. When capped, the poly(arylene ether) may be capped to any desirable extent up to 80 percent, more preferably up to about 90 percent, and even more preferably up to 100 percent of the hydroxy groups are capped. Suitable capped poly(arylene ether) and their preparation are described in U.S. Pat. No. 4,760,118 to White et al. and U.S. Pat. No. 6,306,978 to Braat et al.

Capping poly(arylene ether) with polysalicylate is also believed to reduce the amount of aminoalkyl terminated groups present in the poly(arylene ether) chain. The aminoalkyl groups are the result of oxidative coupling reactions that employ amines in the process to produce the poly(arylene ether). The aminoalkyl group, ortho to the terminal hydroxy group of the poly(arylene ether), is susceptible to decomposition at high temperatures. The decomposition is believed to result in the regeneration of primary or secondary amine and the production of a quinone methide end group, which may in turn generate a 2,6-dialkyl-1-hydroxyphenyl end group. Capping of poly(arylene ether) containing aminoalkyl groups with polysalicylate is believed to remove such amino groups to result in a capped terminal hydroxy group of the polymer chain and the formation of 2-hydroxy-N,N-alkylbenzamine (salicylamide). The removal of the amino group and the capping provides a poly(arylene ether) that is more stable to high temperatures, thereby resulting in fewer degradative products, such as gels or black specks, during processing of the poly(arylene ether).

Based upon the foregoing, it will be apparent to those skilled in the art that the contemplated poly(arylene ether) resin may include many of those poly(arylene ether) resins presently known, irrespective of variations in structural units or ancillary chemical features.

The polymeric material may further comprise a poly(alkenyl aromatic) resin. The term poly(alkenyl aromatic) resin as used herein includes polymers prepared by methods known in the art including bulk, suspension, and emulsion polymerization, which contain at least 25 percent by weight of structural units derived from an alkenyl aromatic monomer of the formula (II) 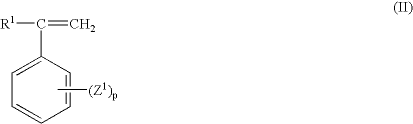
wherein R¹ is hydrogen, C₁-C₈ alkyl, or halogen; Z¹ is vinyl, halogen or C₁-C₈ alkyl; and p is 0 to 5. Preferred alkenyl aromatic monomers include styrene, chlorostyrene, and vinyltoluene. The poly(alkenyl aromatic) resins include homopolymers of an alkenyl aromatic monomer; random copolymers of an alkenyl aromatic monomer, such as styrene, with one or more different monomers such as acrylonitrile, butadiene, alpha-methylstyrene, ethylvinylbenzene, divinylbenzene and maleic anhydride; and rubber-modified poly(alkenyl aromatic) resins comprising blends and/or grafts of a rubber modifier and a homopolymer of an alkenyl aromatic monomer (as described above), wherein the rubber modifier may be a polymerization product of at least one C₄-C₁₀ nonaromatic diene monomer, such as butadiene or isoprene, and wherein the rubber-modified poly(alkenyl aromatic) resin comprises about 98 to about 70 weight percent of the homopolymer of an alkenyl aromatic monomer and about 2 to about 30 weight percent of the rubber modifier, preferably about 88 to about 94 weight percent of the homopolymer of an alkenyl aromatic monomer and about 6 to about 12 weight percent of the rubber modifier. These rubber modified polystyrenes include high impact polystyrene (commonly referred to as HIPS).

The poly(alkenyl aromatic) resins also include non-elastomeric block copolymers, for example diblock, triblock, and multiblock copolymers of styrene and a polyolefin. Non-elastomeric block copolymer compositions of styrene and butadiene can also be used that have linear block, radial block or tapered block copolymer architectures wherein the butadiene component is present up to about 35 weight percent. They are commercially available from such companies as Atofina as under the trademark FINACLEAR and Chevron Phillips Chemical Company under the trademark K-RESINS.

The poly(alkenyl aromatic) resins may also include block copolymers of styrene-polyolefin-methyl methacrylate, especially poly(styrene-b-1,4butadiene-b-methyl methacrylate (SBM) available from Atofina comprising blocks of polystyrene, 1,4-polybutadiene, and syndiotactic polymethyl methacrylate. SBM block copolymers available from Atofina include AF-X223, AF-X333, AF-X012, AF-X342, AF-X004, and AF-X250.

A preferred poly(alkenyl aromatic) is a homopolymer of the alkenyl aromatic monomer (II) wherein R¹ is hydrogen, lower alkyl or halogen; Z¹ is vinyl, halogen or lower alkyl; and p is from 0 to 5. A particularly preferred homopolymer of an alkenyl aromatic monomer is the homopolymer derived from styrene (i.e., homopolystyrene). The homopolystyrene preferably comprises at least 99% of its weight, more preferably 100% of its weight, from styrene.

The stereoregularity of the poly(alkenyl aromatic) resin may be atactic or syndiotactic. Highly preferred poly(alkenyl aromatic) resins include atactic and syndiotactic homopolystyrenes. Suitable atactic homopolystyrenes are commercially available as, for example, EB3300 from Chevron, and P1800 from BASF. Atactic homopolystyrenes are sometimes referred to herein as “crystal polystyrene” resins. Useful syndiotactic polystyrene resins (SPS) are available from The Dow Chemical Company under the QUESTRA trademark.

The poly(alkenyl aromatic) may have a number average molecular weight of about 20,000-100,000 atomic mass units (amu) and a weight average molecular weight of about 10,000-300,000 amu.

When a blend of poly(arylene ether) and poly(alkenyl aromatic) is used to form the disks the amount of poly(arylene ether) is of about 1 to about 99 weight percent based on the total weight of poly(arylene ether) and poly(alkenyl aromatic). Within this range, the amount of poly(arylene ether) used may be less than or equal to about 80 weight percent, with less than or equal to about 70 weight percent preferred, and less than or equal to about 60 weight percent more preferred. Also preferred within this range is an amount of poly(arylene ether) of greater than or equal to about 20 weight percent, with greater than or equal to about 30 weight percent preferred, and greater than or equal to about 40 weight percent more preferred.

Data storage assemblies prepared from disk substrates described herein may comprise a data storage layer disposed on the disk substrate. The data storage assemblies may further comprise additional layers used in the art such as a dielectric layer, a protective layer, a reflective layer, and the like. In a preferred embodiment, the data storage assembly comprises a polymeric disk substrate, a data storage layer disposed on the substrate, an adhesive layer disposed on the data storage layer, and a protective layer disposed on the adhesive layer.

The data storage layer may comprise any material capable of storing retrievable data, such as an optical layer, magnetic layer, or a magneto-optic layer, having a thickness of less than or equal to about 600 angstroms, with a thickness less than or equal to about 300 angstroms preferred. Possible data storage layers include, but are not limited to, oxides (such as silicone oxide), rare earth element-transition metal alloy, nickel, cobalt, chromium, tantalum, platinum, terbium, gadolinium, iron, boron, others, and alloys and combinations comprising at least one of the foregoing, organic dye (e.g., cyanine or phthalocyanine type dyes), and inorganic phase change compounds (e.g., TeSeSn or InAgSb).

The data storage layer may be applied to the disk substrate by a sputtering process, electroplating, or coating techniques (spin coating, spray coating, vapor deposition, screen printing, painting, dipping, sputtering, vacuum deposition, electrodeposition, meniscus coating, and the like).

The protective layer, which protects the data layer against dust, oils, and other contaminants, may have a thickness of greater than or equal to about 100 micrometers to less than or equal to about 10 angstroms, with a thickness of less than or equal to about 300 angstroms preferred in some embodiments, and a thickness of less than or equal to about 100 angstroms especially preferred. The thickness of the protective layer is usually determined, at least in part, by the type of read/write mechanism employed, e.g., magnetic, optic, or magneto-optic. Possible materials for the protective layer includes anti-corrosive materials such as nitrides (e.g., silicon nitrides and aluminum nitrides, among others), carbides (e.g., silicon carbide and others), oxides (e.g., silicon dioxide and others), polymeric materials (e.g., polyacrylates or polycarbonates), carbon film (diamond, diamond-like carbon, etc.), among others, and reaction products and combinations comprising at least one of the foregoing.

Particularly suitable materials for the protective layer includes polycarbonate. As used herein, the term polycarbonate includes compositions having structural units of the formula (III) 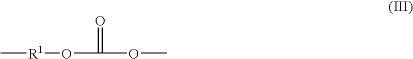
in which at least about 60 percent of the total number of R¹ groups are aromatic organic radicals and the balance thereof are aliphatic, alicyclic, or aromatic radicals. Preferably, R¹ is an aromatic organic radical and, more preferably, a radical of the formula (IV)
—A¹—Y¹—A² (IV)
wherein each of A¹ and A² is a monocyclic divalent aryl radical and Y¹ is a bridging radical having one or two atoms which separate A¹ from A². In an exemplary embodiment, one atom separates A¹ from A². Illustrative non-limiting examples of radicals of this type are —O—, —S—, —S(O)—, —S(O)₂—, —C(O)—, methylene, cyclohexylmethylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ can be a hydrocarbon group or a saturated hydrocarbon group such as methylene, cyclohexylidene or isopropylidene.

Suitable polycarbonates may be made using any process known in the art, including interfacial, solution, solid state, or melt processes.

The protective film layer may be laminated to the substrate and data storage layer using an adhesive layer. Suitable adhesives include rubber-based or rubber-like material such as natural rubber, acrylic ester polymers, or silicone rubber, and the like. Other adhesive materials include polyisoprene, styrene butadiene rubber, ethylene propylene rubber, fluoro vinyl methyl siloxane, chlorinated isobutene-isoprene, chloroprene, chlorinated polyethylene, chlorosufonated polyethylene, butyl acrylate, expanded polystyrene, expanded polyethylene, expanded polypropylene, foamed polyurethane, plasticized polyvinyl chloride, dimethyl silicone polymers, methyl vinyl silicone, polyvinyl acetate and the like. Pressure sensitive adhesives are preferred.

Articles prepared from the disk substrate includes data storage media, such as but not limited to, optical, magneto or magneto-optical data storage media. Such media include compact discs, re-writable compact discs, digital versatile disks, high density disks for data archival technology (DVR, such as BLU-RAY DISC), and the like. A preferred data storage media that may be prepared from disk substrates prepared as described herein is disclosed in application Ser. No. ______, docket no. 120801 entitled “STORAGE MEDIUM FOR DATA WITH IMPROVED DIMENSIONAL STABILITY” filed ______ and copending with the present application.

All cited patents, patent applications, and other references are incorporated herein by reference in their entirety. The invention is further illustrated by the following non-limiting example.

### EXAMPLE

Example 1 illustrates a method of injection molding a polyphenylene ether-polystyrene disk substrate comprising molded-in features. The final substrates are used to form laminated disk assemblies comprising dissimilar materials, wherein the assemblies exhibit excellent dimensional stability and feature replication. A blend of 50 weight percent polyphenylene ether (Polyphenylene Oxide, PPE, 0.33 IV as measured in chloroform at 25° C.) and 50 weight percent crystal polystyrene (xPS, L3450 grade, weight average molecular weight (Mw) 270,000 available from Chevron Phillips Chemical) was used to prepare the disk substrates. Based on the glass transition temperature (Tg) and viscosity data of the blend at varying temperatures, initial ranges of the molding parameters melt temperature and mold temperature were chosen. A range of molding parameters for injection molding was also determined for the molding parameters of clamp tonnage, hold pressure, and cool time.

The midpoints and extremes of the molding parameter ranges were explored to determine the effects of each molding parameter and/or combinations of molding parameters on the molding optimization of an injection molded disk substrate. Table 1 provides the molding parameters chosen for the initial screening through 17 production runs to produce disk substrates; the melt temperature and the mold temperature are in degrees Celsius (° C.), the clamp tonnage is in tons, the hold pressure is in kilogram-force per centimeter squared (kgf/cm²) and the cool time is in seconds.

TABLE 1

| | | | | | | Average 80° C., | |
|---|---|---|---|---|---|---|---|
| | | | | | | 96 hour radial | |
| | Melt | Mold | Clamp | Hold | Cool | tilt change @ | Std. |
| Run | Temp | Temp | Ton | Pressure | Time | 55 mm (degrees) | Dev. |
| 1 | 330 | 100 | 30 | 25 | 12 | 0.343 | 0.055 |
| 2 | 330 | 100 | 30 | 5 | 7 | 0.412 | 0.125 |
| 3 | 330 | 100 | 15 | 25 | 7 | 0.258 | 0.025 |
| 4 | 330 | 100 | 15 | 5 | 12 | 0.263 | 0.020 |
| 5 | 330 | 120 | 15 | 5 | 7 | 0.128 | 0.020 |
| 6 | 330 | 120 | 15 | 25 | 12 | 0.100 | 0.108 |
| 7 | 330 | 120 | 30 | 25 | 7 | 0.218 | 0.116 |
| 8 | 330 | 120 | 30 | 5 | 12 | 0.348 | 0.125 |
| 9 | 345 | 110 | 22.5 | 15 | 9.5 | 0.268 | 0.025 |
| 10 | 360 | 100 | 30 | 25 | 7 | 0.467 | 0.115 |
| 11 | 360 | 100 | 30 | 5 | 12 | 0.473 | 0.018 |
| 12 | 360 | 100 | 15 | 25 | 12 | 0.297 | 0.040 |
| 13 | 360 | 100 | 15 | 5 | 7 | 0.305 | 0.013 |
| 14 | 360 | 120 | 15 | 25 | 7 | 0.213 | 0.010 |
| 15 | 360 | 120 | 15 | 5 | 12 | 0.263 | 0.102 |
| 16 | 360 | 120 | 30 | 5 | 7 | 0.325 | 0.038 |
| 17 | 360 | 120 | 30 | 25 | 12 | 0.475 | 0.108 |
| CE 1 | — | — | — | — | — | 0.505 | 0.038 |

Disk substrates were injection molded according to an initial molding model having molding parameters as provided in Table 1. The disks were injection molded using a Sumitomo Heavy Industries, Ltd. SD30 Injection Molding Machine with a Siekoh Giken Type J CD mold and a stamper having 44 nanometer tall features, which corresponds to a groove depth of 44 nanometers in a disk having 100% mold replication. A typical polymer melt shot size was approximately 20 grams.

One surface of the molded disk substrates contained the negative pattern of grooves from the mold stamper. This surface was metallized with aluminum to a standard thickness of about 0.05-0.10 micrometers by a sputtering process. A pressure sensitive adhesive layer (approximately 25 micrometers in thickness) was applied to the metallized portion of the disk followed by a clear protective film layer of 1,3-bis(4-hydroxyphenyl)menthane polycarbonate (BHPM-PC, prepared from 4,4′-[1-methyl-4-(1-methylethyl)-1,3-cyclohexandiyl]bisphenol (also referred to as BPT-2)) (75 micrometers in thickness) using a nitto tape applicator manufactured by Record Products of America. The disk assembly was completed by placing the stack in a Carver laminator press at 60° C. and 80 pounds per square inch (psi; 5.6 kgf/cm²) for 5 minutes to fully bond the layers.

Thermal aging study: The affect on the radial tilt of the disk assemblies after thermal aging was performed. The disk assemblies from the initial screening were allowed to equilibrate to ambient conditions and the initial radial tilt was measured for each disk assembly. The radial tilt was measured using a Dr. Schenk Prometeus model MT-136E analyzer measuring radial deviation, or twice the radial tilt, as a function of disk radius (measured at a radius of 55 millimeters), using a red laser and modeling the disks as having CD-R format. The disk assemblies were then aged by exposure to 80° C. and 50% relative humidity for 96 hours, re-equilibrated to ambient conditions, and measured again for radial tilt. The change in radial tilt is calculated by subtracting the initial radial tilt before aging from the radial tilt after aging at 80° C. and 50% relative humidity for 96 hours. The results of tilt change are provided in Table 1 as an average of the measurements of three disk assemblies per molding run with units in degrees. The standard deviation is also included in the table. A comparative disk assembly of a Bisphenol A-polycarbonate disk of grade OQ1050 (BPA-PC optical quality polycarbonate 1050 available from GE Plastics) bonded to a BPA-PC film using the same pressure sensitive adhesive as used in the Example was also tested and the results are provided in Table 1 as Comparative Example 1 (CE 1).

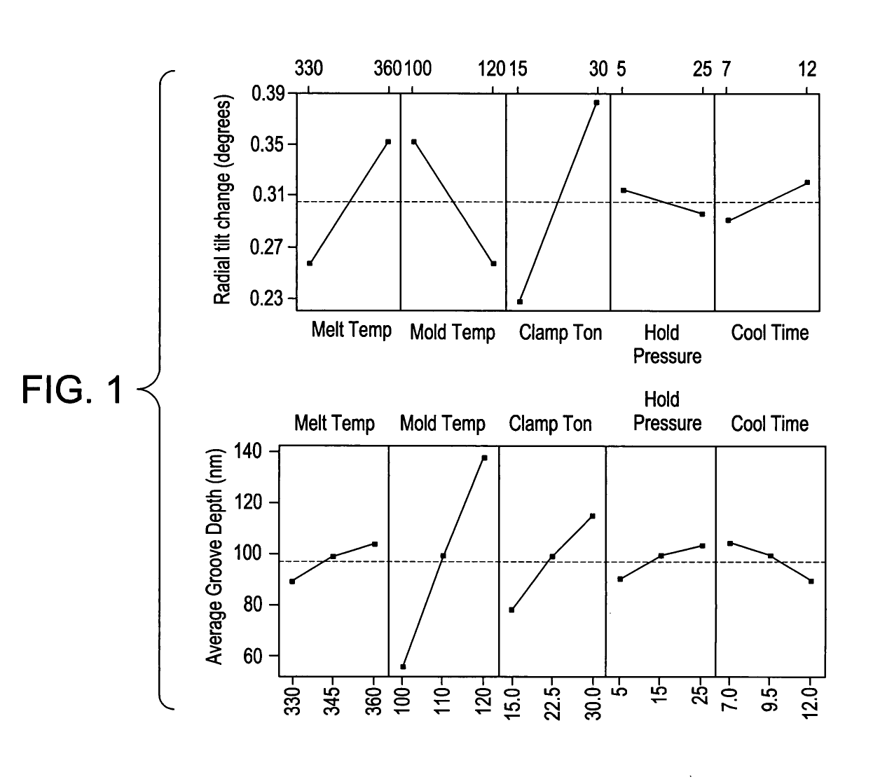

As is illustrated in Table 1, the molding parameters have a significant impact on the radial tilt performance of the disk assemblies. FIG. 1 displays graphs corresponding to the effect of each of the initial molding parameters to the radial tilt in degrees and to the average groove depth replication in nanometers. From FIG. 1 it can be seen that the molding parameters, mold temperature, melt temperature, and clamp tonnage, most significantly affected the radial tilt and replication. The molding parameters having the greatest effect on these two properties were chosen to form an updated molding model. The molding parameters not significantly affecting radial tilt performance and percent replication, such as hold pressure and cool time, were kept at a constant value in the updated molding model.

Table 2 provides the updated molding parameters and the range of updated molding parameter values used in the updated molding model. These values were determined using statistical analysis of the initial values to find a processing window producing a better disk with regards to radial tilt and replication. As the hold pressure and the cool time were determined to not significantly affect the radial tilt performance or percent replication, these molding parameters were kept at a constant value in the updated molding model (25 kgf/cm² and 12 seconds, respectively). Fifteen more injection molding runs were performed to produce disk substrates based on the updated molding model. Disk assemblies were prepared from the disk substrates as described previously. Additionally, for runs 18, 21, 26, 27, 29, and 30 additional disk assemblies were prepared using a BPA-PC protective film to explore the effect on radial tilt of BPA-PC film compared to BHPM-PC film. The disk assemblies were subjected to an 80° C. thermal aging study as described previously and the results are provided in Table 2 as an average of testing three disk assemblies. A comparative disk assembly of a BPA-PC protective layer bonded to a BPA-PC disk substrate as described above for Comparative Example 1 was also tested (Comparative Example 2 (CE 2)).

TABLE 2

| | | | | | | Average 80° C., 96 | |
|---|---|---|---|---|---|---|---|
| | | | | | | hour radial tilt | |
| | Melt | Mold | Clamp | | | change @ 55 mm | |
| Run | Temp | Temp | Ton | Film | % Rep. | (degrees) | Std. Dev. |
| 18 | 340 | 100 | 20 | BHPM-PC | 61.4^{b} | 0.243 | 0.023 |
| | | | | BPA-PC | 61.4^{b} | 0.245 | 0.005 |
| 19 | 340 | 105 | 30 | BHPM-PC | 98.8^{c} | 0.207 | 0.029 |
| | | | | BPA-PC | N/A^{a} | N/A^{a} | N/A^{a} |
| 20 | 340 | 110 | 15 | BHPM-PC | 59.0^{c} | 0.183 | 0.049 |
| | | | | BPA-PC | N/A^{a} | N/A^{a} | N/A^{a} |
| 21 | 340 | 120 | 25 | BHPM-PC | 101.7^{b} | 0.160 | 0.104 |
| | | | | BPA-PC | 101.7^{b} | 0.100 | 0.017 |
| 22 | 350 | 100 | 15 | BHPM-PC | 50.7^{c} | 0.262 | 0.003 |
| | | | | BPA-PC | N/A^{a} | N/A^{a} | N/A^{a} |
| 23 | 350 | 110 | 25 | BHPM-PC | 89.6^{c} | 0.243 | 0.046 |
| | | | | BPA-PC | N/A^{a} | N/A^{a} | N/A^{a} |
| 24 | 350 | 110 | 25 | BHPM-PC | 107.6^{c} | 0.222 | 0.050 |
| | | | | BPA-PC | N/A^{a} | N/A^{a} | N/A^{a} |
| 25 | 350 | 110 | 25 | BHPM-PC | 94.6^{c} | 0.240 | 0.022 |
| | | | | BPA-PC | N/A^{a} | N/A^{a} | N/A^{a} |
| 26 | 350 | 120 | 20 | BHPM-PC | 99.2^{b} | 0.162 | 0.015 |
| | | | | BPA-PC | 99.2^{b} | 0.217 | 0.080 |
| 27 | 360 | 100 | 30 | BHPM-PC | 79.6^{b} | 0.293 | 0.020 |
| | | | | BPA-PC | 79.6^{b} | 0.205 | 0.106 |
| 28 | 360 | 105 | 20 | BHPM-PC | 80.2^{c} | 0.190 | 0.083 |
| | | | | BPA-PC | N/A^{a} | N/A^{a} | N/A^{a} |
| 29 | 360 | 120 | 15 | BHPM-PC | 108.0^{b} | 0.138 | 0.012 |
| | | | | BPA-PC | 108.0^{b} | 0.082 | 0.058 |
| 30 | 360 | 120 | 30 | BHPM-PC | 98.5^{b} | 0.128 | 0.008 |
| | | | | BPA-PC | 98.5^{b} | 0.122 | 0.012 |
| 31 | 350 | 120 | 20 | BHPM-PC | 92.0^{c} | 0.210 | 0.096 |
| | | | | BPA-PC | N/A^{a} | N/A^{a} | N/A^{a} |
| 32 | 340 | 120 | 25 | BHPM-PC | 95.3^{c} | 0.140 | 0.018 |
| | | | | BPA-PC | N/A^{a} | N/A^{a} | N/A^{a} |
| CE 2 | | | | BPA-PC | | 0.285 | 0.009 |

^{a}N/A = not available
^{b}Average of six disk assemblies, three BHPM-PC and three BPA-PC (Runs 18, 21, 26, 27, 29, and 30)
^{c}Average of three BHPM-PG disk assemblies (Runs 19, 20, 22-25, 28, 31, and 32)

The results of the thermal aging study illustrates that the choice of film material (BPA or BHPM) has less effect on the radial tilt change as compared to the molding conditions (Table 2). Table 2 further provides the percent replication (% Rep.) results of the disk substrates molded according to the updated molding model. The percent replication was determined by measuring the groove depth of the disk feature using an atomic force microscope and dividing the number obtained by the measurement of the corresponding mold stamper pattern feature and multiplying by 100. The percent replication data provided in Table 2 represents an average value.

The radial tilt data provided by the 80° C. aging study and the % replication data may be used to formulate a transfer function capable of predicting both 80° C. radial tilt change as well as % replication as a function of each of the three molding parameters: melt temperature, mold temperature, and clamp tonnage. The transfer functions may be developed to relate the empirical relationship between the molding parameters and the resulting radial tilt and % replication using statistical algorithms such as regression analysis to determine which molding factors were statistically significant, and their impact on the disk response. The transfer functions in turn may be used to identify or predict an optimum set of molding conditions for a particular formulation of interest.

As shown by the foregoing Example, a molding model can be created to formulate the optimum molding conditions for an injection molded disk comprising a blend of polyphenylene ether-polystyrene. By optimizing the molding conditions, disks can be molded that exhibit excellent physical stability (as shown by the 80° C. aging study of a change in tilt of less than 0.3 degrees) and excellent percent feature replication of the mold stamper features (greater than 90%).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the appended claims.

1. A method of molding a disk, comprising injection molding a polymeric material at a melt temperature of about 330 to about 370° C. into a mold having a mold temperature of about 90 to about 130° C. and a clamp tonnage of about 12 to about 35 tons to form a disk.

2. The method of claim 1, wherein a disk assembly fabricated from the disk exhibits a radial tilt change value after 96 hours at 80° C. of less than or equal to about 0.35 degree measured at a radius of 55 millimeters.

3. The method of claim 1, wherein a disk assembly fabricated from the disk exhibits a radial tilt change value after 96 hours at 80° C. of less than or equal to about 0.15 degree measured at a radius of 55 millimeters.

4. The method of claim 1, wherein the melt temperature is of about 340 to about 360° C.

5. The method of claim 1, wherein the mold temperature is of about 100 to about 120° C.

6. The method of claim 1, wherein the clamp tonnage is of about 15 to about 30 tons.

7. The method of claim 1, wherein the disk exhibits a percent feature replication of greater than or equal to about 90 percent.

8. The method of claim 1, wherein the disk exhibits a percent feature replication of greater than or equal to about 95 percent.

9. The method of claim 1, wherein the polymeric material comprises poly(arylene ether) and poly(alkenyl aromatic).

10. The method of claim 9, wherein the poly(arylene ether) comprises a plurality of structural units of the structure 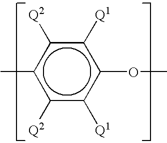
wherein for each structural unit, each Q¹ is independently halogen, primary or secondary C₁-C₇ alkyl, phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary lower alkyl, phenyl, haloalkyl, hydrocarbonoxy, or halohydrocarbonoxy wherein at least two carbon atoms separate the halogen and oxygen atoms.

11. The method of claim 9, wherein the poly(arylene ether) has an intrinsic viscosity of about 0.10 to about 0.60 deciliters per gram as measured in chloroform at 25° C.

12. The method of claim 9, wherein the poly(alkenyl aromatic) contains at least 25% by weight of structural units derived from an alkenyl aromatic monomer of the formula 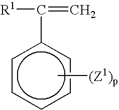
wherein R¹ is hydrogen, C₁-C₈ alkyl, or halogen; Z¹ is vinyl, halogen or C₁-C₈ alkyl; and p is 0 to 5.

13. The method of claim 9, wherein the poly(alkenyl aromatic) is atactic crystal polystyrene.

14. The method of claim 9, wherein the poly(arylene ether) is present in the polymeric material in an amount of about 60 to about 40 percent by weight and the poly(alkenyl aromatic) is present in the polymeric material in an amount of about 40 to about 60 percent by weight based on the total weight of the poly(arylene ether) and the poly(alkenyl aromatic).

15. The method of claim 1, wherein the disk is a data storage disk.

16. A laminate data storage assembly fabricated from a disk formed by the method of claim 1.

17. A method of molding a disk, comprising injection molding a polymeric material at a melt temperature of about 330 to about 370° C. into mold having a mold temperature of about 90 to about 130° C. and a clamp tonnage of about 12 to about 35 tons to form a disk, wherein the polymeric material comprises poly(2,6-dimethyl-1,4-phenylene oxide) and polystyrene.

18. A method of molding a disk, comprising:
injection molding a polymeric material to form disks according to a molding model comprising molding parameters and molding parameter values;
testing disk assemblies fabricated from the disks for radial tilt change;
creating an updated molding model based on the molding parameter values that resulted in disk assemblies fabricated from the disks having a radial tilt change within a selected range of values; and
repeating the molding, testing and creating steps to form final disks and a final molding model, wherein disk assemblies fabricated from the final disks exhibit a radial tilt change value after aging of less than or equal to about 0.35 degree measured at a radius of 55 millimeters.

19. The method of claim 18, wherein the testing comprises aging the disk assemblies at 80° C. for 96 hours.

20. The method of claim 18, wherein the disk assemblies fabricated from the final disks exhibit a radial tilt change value after 96 hours at 80° C. of less than or equal to about 0.35 degree measured at a radius of 55 millimeters.

21. The method of claim 18, wherein the disk assemblies fabricated from the final disks exhibit a radial tilt change value after 96 hours at 80° C. of less than or equal to about 0.15 degree measured at a radius of 55 millimeters.

22. The method of claim 18, further comprising
testing the disks for percent feature replication;
creating the updated molding model based on the molding parameter values that resulted in disks exhibiting a percent feature replication within a selected range of values; and
repeating the molding, testing and creating steps until the final disks exhibit a percent feature replication of greater than or equal to about 90 percent.

23. The method of claim 22, wherein the final disks exhibit a percent feature replication of greater than or equal to about 95%.

24. The method of claim 18, wherein the molding parameters are melt temperature, mold temperature, clamp tonnage, hold pressure, cool time, or a combination thereof.

25. The method of claim 18, wherein the polymeric material is polycarbonate, poly(arylene ether); poly(alkenyl aromatic); polyolefins; diene-derived polymers; polyacrylamide; polyamides; polyesters; polyestercarbonates; polyethersulfones; polyetherketones; polyetherimides; copolymers thereof; or blends of the foregoing.

26. The method of claim 18, wherein the polymeric material comprises poly(arylene ether) and poly(alkenyl aromatic).

27. The method of claim 26, wherein the poly(arylene ether) comprises a plurality of structural units of the structure 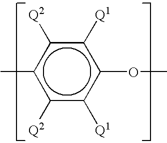
wherein for each structural unit, each Q¹ is independently halogen, primary or secondary C₁-C₇ alkyl, phenyl, haloalkyl, aminoalkyl, hydrocarbonoxy, or halohydrocarbonoxy wherein at least two carbon atoms separate the halogen and oxygen atoms; and each Q² is independently hydrogen, halogen, primary or secondary lower alkyl, phenyl, haloalkyl, hydrocarbonoxy, or halohydrocarbonoxy wherein at least two carbon atoms separate the halogen and oxygen atoms.

28. The method of claim 26, wherein the poly(arylene ether) has an intrinsic viscosity of about 0.10 to about 0.60 deciliters per gram as measured in chloroform at 25° C.

29. The method of claim 26, wherein the poly(alkenyl aromatic) contains at least 25% by weight of structural units derived from an alkenyl aromatic monomer of the formula 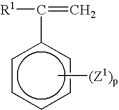
wherein R¹ is hydrogen, C₁-C₈ alkyl, or halogen; Z¹ is vinyl, halogen or C₁-C₈ alkyl; and p is 0 to 5.

30. The method of claim 26, wherein the poly(arylene ether) is present in the polymeric material in an amount of about 90 to about 10 percent by weight and the poly(alkenyl aromatic) is present in the polymeric material in an amount of about 10 to about 90 percent by weight based on the total weight of the poly(arylene ether) and the poly(alkenyl aromatic).

31. A data storage disk formed by the method of claim 18.

32. A laminate data storage assembly fabricated from the final disk formed by the method of claim 18.
